(19) United States
(12) Patent Application Publication
(10) Pub. No.: US 2018/0347728 A1
(43) Pub. Date: Dec. 6, 2018

(54) Gas Valve with Two Nozzles

(71) Applicant: Ningbo Chaoyang Household Gas Stoves Co., Ltd., Ningbo (CN)

(72) Inventor: Xueya Li, Ningbo (CN)

(73) Assignee: Ningbo Chaoyang Household Gas Stoves Co., Ltd.

(21) Appl. No.: 15/956,506

(22) Filed: Apr. 18, 2018

(30) Foreign Application Priority Data
May 31, 2017 (CN) 201710398829.5

(51) Int. Cl. F16L 11/08; F16K 5/20; F16K 27/06

(52) U.S. Cl. CPC F16L 11/083; F16K 31/58; F16K 27/062; F16K 5/202

(57) ABSTRACT

A gas valve with two nozzles includes a valve body having an inlet, a primary outlet and a secondary outlet; a rotatable valve core is disposed inside the valve body; a valve rod inserted into the valve body; a first nozzle connected to a first outlet end of the primary outlet; and a second nozzle connected to a second outlet end of the secondary outlet; wherein, a connection chamber with a top opening for receiving the valve rod is mounted on the upper portion of the valve core; a ventilation chamber in communication with the primary outlet is defined in the lower portion of the valve core, the ventilation chamber having a side wall; a first high fire hole and a low fire hole both for communication between the inlet and the primary outlet are defined on the side wall of the ventilation chamber; and a second high fire hole for communication between the inlet and the primary outlet and a supplementary fire hole for communication between the ventilation chamber and the secondary outlet are defined on the side wall of the ventilation chamber of the valve core. In this gas valve, two nozzles can be kept in a gas injection state simultaneously only by rotating a valve rod to a certain position, without keeping a hand in a pressed-down operation position all the time.

### CROSS REFERENCE TO RELATED PATENT APPLICATION

The present application claims the priority of the Chinese patent application No. 201710398829.5 filed on May 31, 2017 which is incorporated herein by reference.

### FIELD OF THE INVENTION

The present invention relates to a gas valve for a gas cooking appliance, in particular to a gas valve with two nozzles which can output flame having high-power heat.

### DESCRIPTION OF THE PRIOR ART

A cock valve for a gas cooking appliance is a manually-operated valve for controlling the supply of gas. A common cock valve generally comprises a valve body on which an inlet and an outlet are formed. A rotatable valve core is provided inside the valve body. A spring chamber is formed in an upper portion of the valve core, while a ventilation chamber is formed in a lower portion of the valve core. A valve rod capable of driving the valve core to rotate is penetrated through the valve body. A spring for keeping the valve rod in a trend of moving up and disconnecting from the valve core is resisted against a lower end of the valve rod, and the spring is located within the spring chamber on the valve core. A high fire hole and a low fire hole used for communicating the inlet and the outlet are formed on a side wall of the ventilation chamber of the valve core. When in use, a user operates the valve rod through a rotary knob arranged on an operation panel. Generally, the rotary knob is pressed down and then rotated counterclockwise, so that the valve core can be driven to rotate counterclockwise, and the high fire hole on the valve core is communicated with the air inlet passage in the valve body. In this case, gas supply is injected from a nozzle through the inlet, the high fire hole, the ventilation chamber and the outlet, to be used by the gas appliance. When it is necessary to turn down the flame, the user continuously rotates the rotary knob counterclockwise, so that the low fire hole on the valve core is communicated with the air inlet passage in the valve body. Consequently, the flow passage of gas is reduced, and the purpose of turning down the flame is thus achieved. If the user wants to change the low flame to the highest flame again, the user rotates the valve core back, so that the valve core changes from a state where the low fire hole is in communication with the inlet in the valve body to a state where the high fire hole is in communication with the inlet in the valve body.

When frying a steak, in order to fry a steak which is crisp outside and soft inside, the steak needs to be fried over a flame outputting high-power heat, that is, the steak needs to be quickly fried to form lattice-like texture on the surface, so that water inside the steam can be locked during the subsequent frying process. Accordingly, a new requirement is proposed on a gas valve that the gas valve needs to inject gas fiercely at the beginning of frying. Therefore, gas valves with two nozzles which can output high-power heat have appeared on the market.

For example, Chinese Patent CN205780987Y (Patent No.:ZL201620732361.X), entitled COCK VALVE WITH TWO NOZZLES, has disclosed such a gas valve, including a valve body, a first passage formed within the valve body, a valve cover mounted at a rear end of the valve body and a nozzle body mounted at a front end of the valve body, wherein a inlet for being connected to a gas source and a outlet for being connected to the nozzle body are provided on the valve body; the first passage is communicated with the inlet and the outlet, respectively; the outlet includes a primary outlet and a secondary outlet; the nozzle body includes a primary nozzle and a secondary nozzle used for communicating the primary outlet and the secondary outlet, respectively; an axis of the primary outlet and an axis of the first passage are located in a same straight line, and an axis of the secondary outlet is parallel to the axis of the first passage; a gas pipe is provided between the secondary nozzle and the secondary outlet; and, the secondary nozzle is detachably connected to the gas pipe, and the secondary outlet is also detachably connected to the gas pipe.

Fierce injection can be realized in this patent. The operation process is as follows: when the valve is located at a higher position (in a high flame state), the valve rod can be long pressed as required, and the valve plug is moved toward the primary nozzle, so that the inlet is in communication with the secondary outlet, and the primary nozzle and the secondary nozzle are turned on simultaneously to grill over a heavy flame. The secondary nozzle can be turned off just after the valve rod is released. The compression spring will push the valve rod to move toward the valve cover, and the valve plug is also moved and finally blocked between the third passage and the second passage. In this way, the inlet is disconnected from the outlet. The operation flow starts from no flame to high flame. During the fierce injection, it is required to push the valve rod to move down from the high flame position, so that the inlet is in communication with the secondary outlet, and the primary nozzle and the secondary nozzle are turned on simultaneously to grill over a heavy flame. The inlet is disconnected from the secondary outlet after the valve rod is released and returns to its original position. During the operation process of continuously rotating the valve rod to the low flame, the valve rod needs to be always pressed down, so that the operation is strenuous. In addition, outside the valve body, a gas pipe needs to be additionally provided between the secondary nozzle and the secondary gas passage. Accordingly, the overall size of the valve body is large, and it is disadvantageous to assemble the gas valve on a cooking appliance. Moreover, since there are many junctions, it is likely to result in gas leakage at the junctions, and the potential safety hazards are increased.

Nowadays, various energy sources have been developed and utilized, and the original phenomenon of a single energy source has been changed. For example, various gas sources such as liquefied petroleum gas, natural gas and dimethyl ether have been more and more widely applied in gas appliances. When there are gas sources of different types and a change needs to be performed between the gas sources, since different gases are different in heat and low fire holes in gas valves have a fixed size, the low fire holes of the gas valves are not big enough for gases having high heat, and the low fire holes of the gas valves are too big for gases having low heat. In the current era of energy shortage, in many countries, the replacement of a gas source for a whole residential area will often occur. Since different gas sources will make the gas flow required by the gas appliances different, the originally mounted common gas valves specific for only one gas source and the corresponding nozzles need to be replaced. Consequently, the replacement cost is increased greatly, it is disadvantageous for the popularization and application of new gas sources, and it is also disadvantageous for the implementation of the replacement of gas sources.

In conclusion, further improvements needs to be made to the existing gas valves with two nozzles.

### SUMMARY OF THE INVENTION

It is an object of the present invention to provide a gas valve with two nozzles, which has a rational and compact structure design. In this gas valve of the present invention, two nozzles can be kept in a gas injection state simultaneously only by rotating a valve rod to a certain position, without keeping a hand in a pressed-down operation position all the time. The operation is more humanized.

For achieving this object, the gas valve with two nozzles comprises:

A valve body having a gas inlet and a primary gas outlet and a secondary outlet; a rotatable valve core is disposed inside the valve body, having an upper portion and a lower portion; a valve rod inserted into the valve body; a first nozzle is connected to a first outlet end of the primary outlet and a second nozzle is connected to a second outlet end of the second outlet; a connection chamber with a top opening for receiving the valve rod is mounted on the upper portion of the valve core; a ventilation chamber in communication with the primary outlet is defined in the lower portion of the valve core, the ventilation chamber having a side wall; a first high fire hole and a low fire hole both for communication between the inlet and the primary outlet are defined on the side wall of the ventilation chamber; and a second high fire hole for communication between the inlet and the primary outlet and a supplementary fire hole for communication between the ventilation chamber and the secondary outlet are defined on the side wall of the ventilation chamber of the valve core.

Preferably, the inlet, the first high fire hole, the second high fire hole, the low fire hole, the supplementary fire hole and the secondary outlet meet the following conditions: when the valve core is rotated from an initial position (defined as 0°) to a first angle, the inlet is in communication with the first high fire hole, the inlet is not in communication with the second high fire hole and the low fire hole, and the supplementary fire hole is not in communication with the secondary outlet; when the valve core is rotated from the first angle to a second angle, the inlet is communicated with the low fire hole, the inlet is not in communication with the first high fire hole and the second high fire hole, and the supplementary fire hole is not in communication with the secondary outlet; and, when the valve core is rotated from the second angle to a third angle, the inlet is in communication with the second high fire hole, the inlet is not in communication with the first high fire hole and the low fire hole, and the supplementary fire hole is communicated with the secondary outlet. During this process, the control process of the gas valve is regionalized and rationalized. During every rotation to an angle, different outlet states can be realized. When the valve core is rotated to the first angle, the outlet state is high flame, it is the most suitable time for ignition, and the ignition success rate is high; when the valve core is rotated to the second angle, the gas outlet state is low flame, so that the adjustment of flame is realized; and, when the valve core is rotated to the third angle, fierce injection is realized by two nozzles. It is most reasonable to set the third angle as the final angle, since the fierce injection by two nozzles will not be always needed. It is improper to set the third angle before the second angle or the first angle.

Preferably, an axis of the primary outlet is parallel to an axis of the secondary outlet, and a connecting hole for communication the secondary outlet the with the second high fire hole is formed at a side wall of the top of the secondary outlet. With this structure, the primary outlet and the secondary outlet can be arranged adjacent to each other, so that the miniaturization of the size of the valve body is ensured. If the axis of the secondary outlet is arranged obliquely with respect to the axis of the primary outlet, the size of the valve body will become larger.

Preferably, the ventilation chamber and the connection chamber are connected to each other through a threaded connection hole which is axially defined inside the valve core; an auxiliary low fire hole communicating with the threaded connection hole is formed on a side wall of the valve core; the auxiliary low fire hole is located above the low fire hole; and, an adjustment screw moves inside the threaded connection hole so as to adjust communication between the auxiliary low fire hole and the ventilation chamber.

With this structure, two gas sources can be used by the gas valve, when a gas having high heat is needed, it is only required to screw the adjustment screw, so that the adjustment screw blocks the auxiliary low fire hole, only the low fire hole works, and the gas flow becomes lower; however, when a gas having high heat is needed, the adjustment screw is unscrewed, both the low fire hole and the auxiliary low fire hole are communicated with the ventilation chamber, and the gas flow becomes higher. During the change between the two gas sources, two different gas sources can be supported only by rotating the adjustment screw. Moreover, since the low fire hole and the auxiliary low fire hole are located in a same vertical plane, there are only two gears similar to the valve core of the conventional gas core, and it is not required to provide any complicated limiting structure, so that the structure of the gas valve using this valve core can be simplified.

Preferably, the threaded connection hole has a threaded hole portion at the upper thereof, and an unthreaded hole portion at the lower thereof; the auxiliary low fire hole is communicated with the threaded hole portion; the adjustment screw has a head, an annular groove portion, a threaded portion and an unthreaded rod portion successively from top to bottom; an inner peripheral wall of the connection chamber is sheathed on the annular groove portion to form an airtight seal ring; the threaded portion is in threaded connection to the threaded hole portion; and the unthreaded rod portion can realize blockage with the unthreaded hole portion. The arrangement of the seal ring ensures that the gas will not enter the connection chamber, so that the safety in use is ensured. In addition, by fitting the unthreaded hole portion and the unthreaded rod portion, the adjustment screw can be moved down to better block the threaded connection hole, so that the auxiliary low fire hole and the ventilation chamber can be blocked effectively.

Preferably, the unthreaded rod portion has a conical periphery surface, and the unthreaded rod portion has a conical inner wall matching with the unthreaded hole portion, to realize better blockage.

Preferably, both the low fire hole and the auxiliary low fire hole have a step at the side wall thereof. Since the outside of the low fire hole is a large hole portion, the large area is convenient for the superposition with the gas inlet of the valve body; and, the low fire hole, as a stepped hole, can ensure that a small amount of gas through the low fire hole, so that the low flame is adjusted effectively.

A laterally raised connecting column is provided on the valve body; a slot which is arranged axially and has an upward opening for allowing the connecting column to be inserted therein is formed on a circumferential surface of the connection chamber; in a state of moving up the valve rod, the connecting rod is located above the slot; and, in a state of moving down the valve rod, the connecting column is located within the slot.

Preferably, to conveniently adjust the adjustment screw, a perforation for allowing an adjustment hand tool to pass through is arranged on the valve rod. During the adjustment, the adjustment screw can be adjusted by allowing the hand tool to directly pass through the perforation, without disassembling the valve rod.

Preferably, for the convenience of assembly, a valve housing and a valve cover via connecting with each other forms the valve body; all the inlet passage, the primary outlet passage and the secondary outlet passage are arranged on the valve housing; and, the valve rod is inserted through the valve cover.

Compared with the prior art, the present invention has the following advantages:

The secondary outlet for realizing fierce injection is completely provided inside the valve body, and no additional connecting pipe is provided outside the valve body, so that the overall size of the gas valve can be reduced, and it is advantageous for mounting. Meanwhile, compared with an existing gas valve with two nozzles, two junctions are cancelled, and the risk of gas leakage is reduced.

Since a second high fire hole for communicating the inlet and a complementary fire hole for connecting the secondary outlet are additionally provided on the valve core, the gas valve can work in three operation modes. In a two-nozzle operation mode, when the valve core is rotated to a certain angle, it is ensured that the inlet is communicated with the second high fire hole, the inlet is not communicated with the first high fire hole and the low fire hole, and the supplementary fire hole is communicated with the secondary outlet. In this way, gas is communicated with the primary outlet through the inlet, the second high fire hole and the ventilation chamber. Meanwhile, the gas is communicated with the secondary outlet through the ventilation chamber and the supplementary fire hole, so that gas is injected from both the primary outlet and the secondary outlet. During this process, the valve rod does not need to be operated manually, and the valve core is automatically kept at this position. When the two-nozzle mode is not required, it is only required to rotate the valve rod reversely, and the operation is more humanized.

### BRIEF DESCRIPTION OF THE DRAWINGS

FIG. 1 is a perspective view of a gas valve with two nozzles according to an embodiment of the present invention.

FIG. 2 is a sectional view of the gas valve according to the embodiment of the present invention (at an initial position defined as 0°);

FIG. 3 is a sectional view of the gas valve according to the embodiment of the present invention (at 90°);

FIG. 4 is a sectional view of the gas valve according to the embodiment of the present invention (at 165°);

FIG. 5 is a sectional view of the gas valve according to the embodiment of the present invention (at 230°);

FIG. 6 is a sectional view of the gas valve according to the embodiment of the present invention (at 230°);

FIG. 7 is a first perspective view of the valve core according to the embodiment of the present invention;

FIG. 8 is a second perspective view of the valve core according to the embodiment of the present invention;

FIG. 9 is a sectional view of the valve core according to the embodiment of the present invention (in a state where an adjustment screw blocks an auxiliary low flame hole);

FIG. 10 is a sectional view of the valve core according to the embodiment of the present invention (in a state where the adjustment screw opens the auxiliary low flame hole); and

FIG. 11 is an exploded view of the valve core according to the embodiment of the present invention.

### DETAILED DESCRIPTION OF THE PREFERRED EMBODIMENT

To enable a further understanding of the innovative and technological content of the invention herein, refer to the detailed description of the invention and the accompanying drawings below:

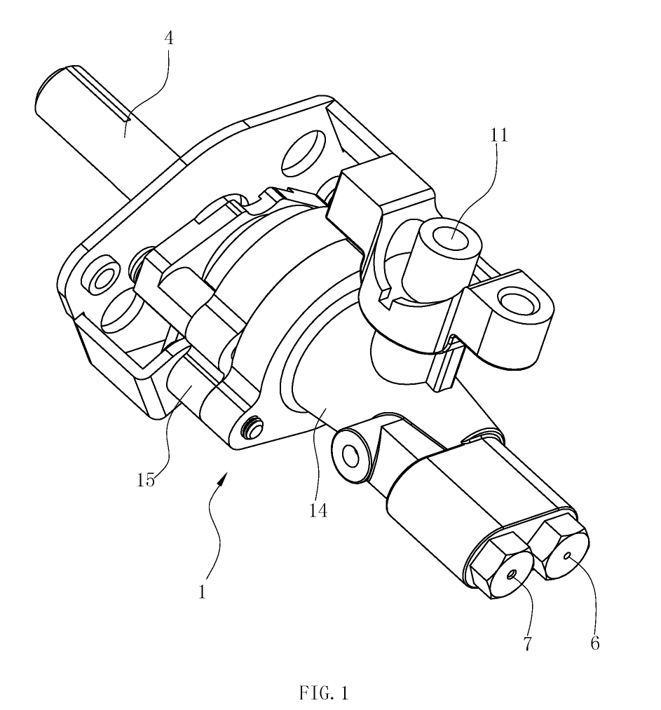

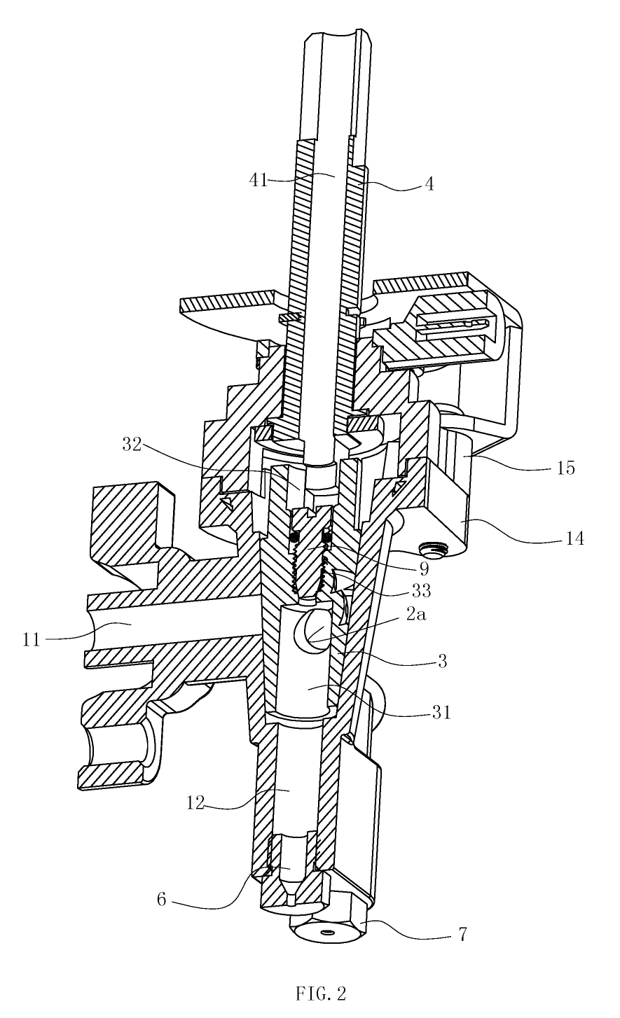

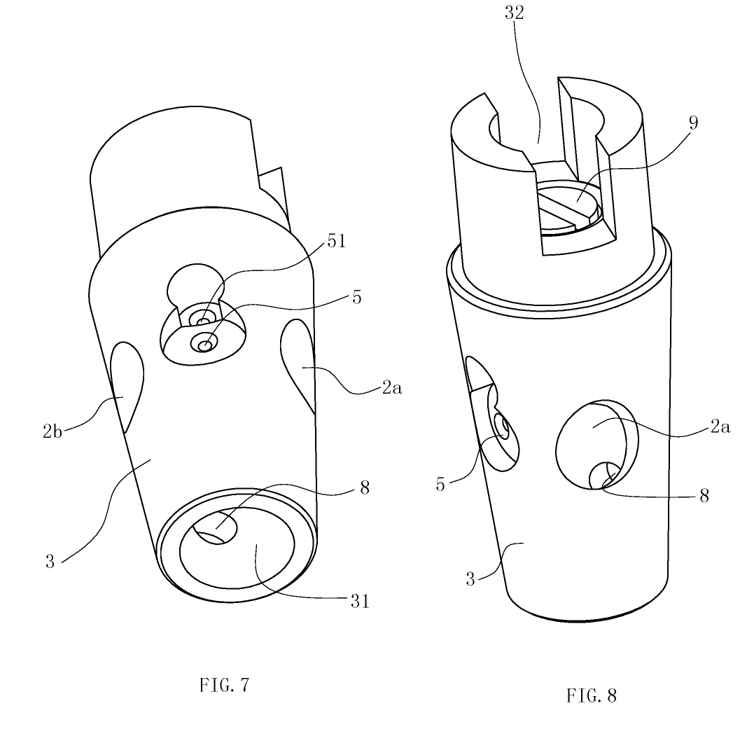

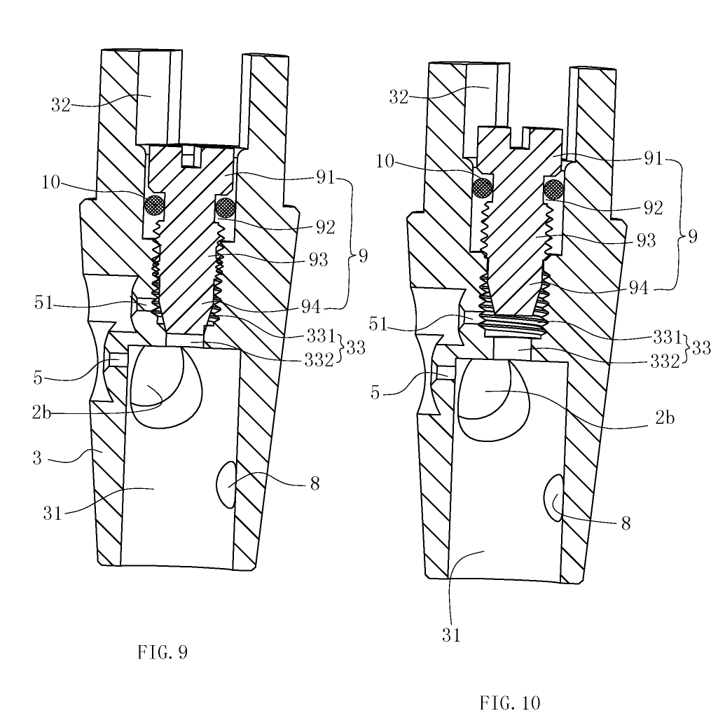

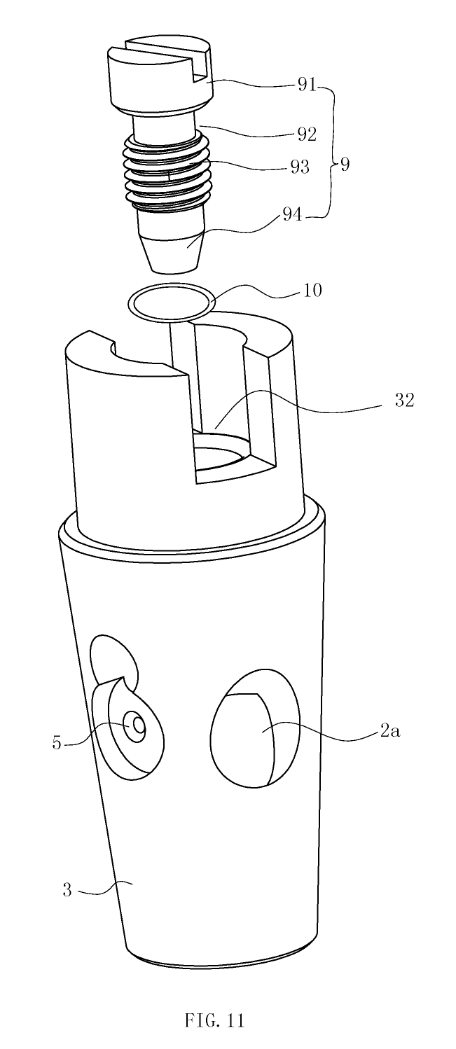

FIGS. 1-11 show a prefer embodiment of the present invention.

The gas valve with two nozzles comprises a valve body 1, a rotatable valve core 3, a valve rod 4, a first nozzle 6, and a second nozzle 7.

The valve body 1 has an inlet 11, a primary outlet 12 and a secondary outlet 13. The rotatable valve core 3 is disposed inside the valve body 1, having an upper portion and a lower portion. The valve rod 4 is inserted into the valve body 1. The first nozzle 6 connected to a first outlet end of the primary outlet 12, and the valve rod 4 has a perforation 41 for allowing an adjustment hand tool to pass through. The second nozzle 7 is connected to a second outlet end of the secondary outlet 13.

A connection chamber 32 with a top opening for receiving the valve rod 4 is mounted on the upper portion of the valve core 3.

A ventilation chamber 31 in communication with the primary outlet 12 is defined in the lower portion of the valve core 3, the ventilation chamber 31 has a side wall. A first high fire hole 2a and a low fire hole 5 both for communication between the inlet 11 and the primary outlet 12 are defined on the side wall of the ventilation chamber 31. And a second high fire hole 2b for communication between the inlet 11 and the primary outlet 12 and a supplementary fire hole 8 for communication between the ventilation chamber 31 and the secondary outlet 13 are defined on the side wall of the ventilation chamber 31 of the valve core 3.

A valve housing 14 and a valve cover 15 is connected with each other forms on the valve body 1. All the inlet 11, the primary outlet 12 and the secondary outlet 13 are arranged on the valve housing 14; and the valve rod 4 is inserted through the valve cover 15.

The inlet 11, the first high fire hole 2a, the second high fire hole 2b, the low fire hole 5, the supplementary fire hole 8 and the secondary outlet 13 meet the following conditions.

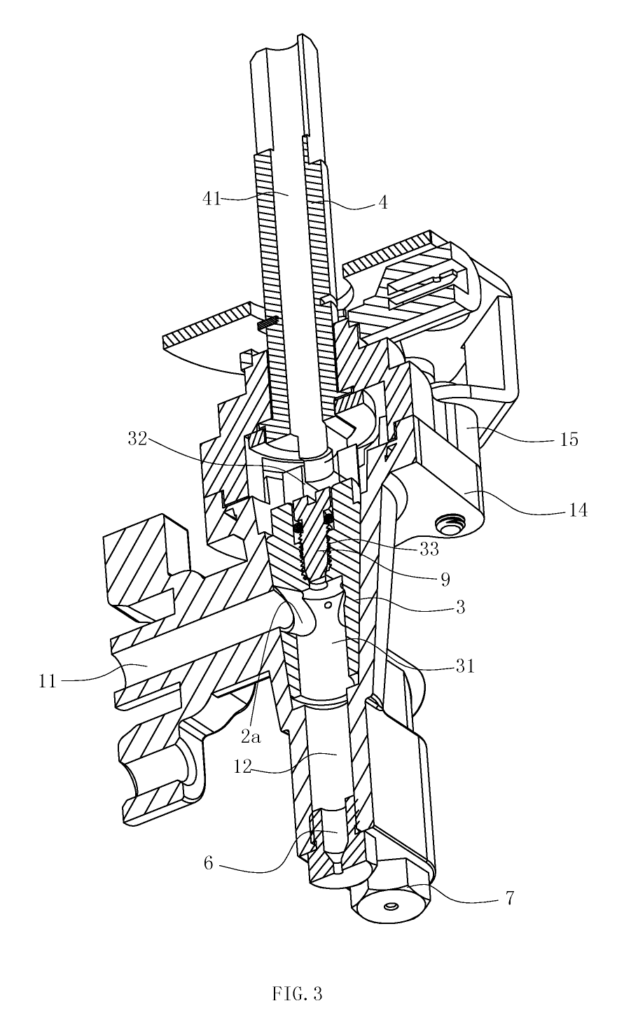

As shown in FIG. 3, when the valve core is rotated from an initial position which defined as 0° to a first angle α which may be 90°, the inlet 11 is in communication with the first high fire hole 2a, the inlet 11 is not in communication with the second high fire hole 2b and the low fire hole 5, and the supplementary fire hole 8 is not in communication with the secondary outlet 13.

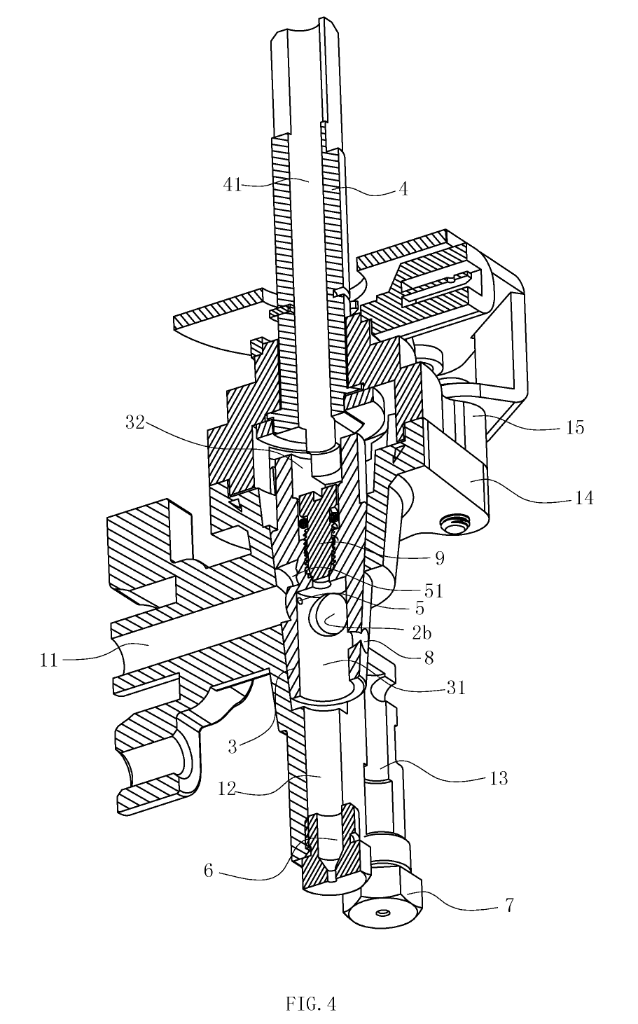

As shown in FIG. 4, when the valve core is rotated from the first angle α to a second angle β which may be 165°, the inlet 11 is communicated with the low fire hole 5, the inlet 11 is not in communication with the first high fire hole 2a and the second high fire hole 2b, and the supplementary fire hole 8 is not in communication with the secondary outlet 13.

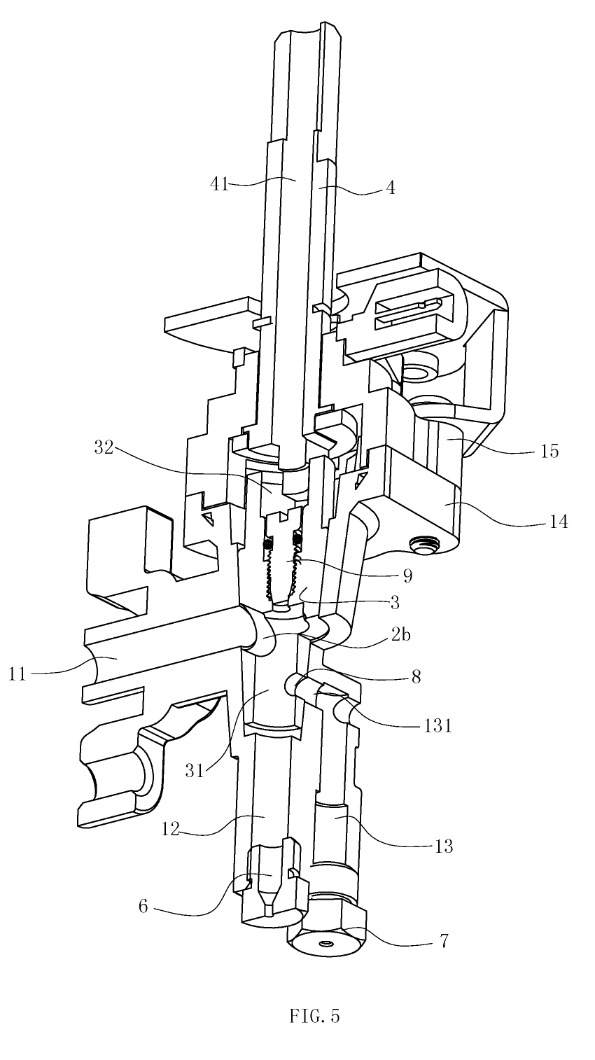

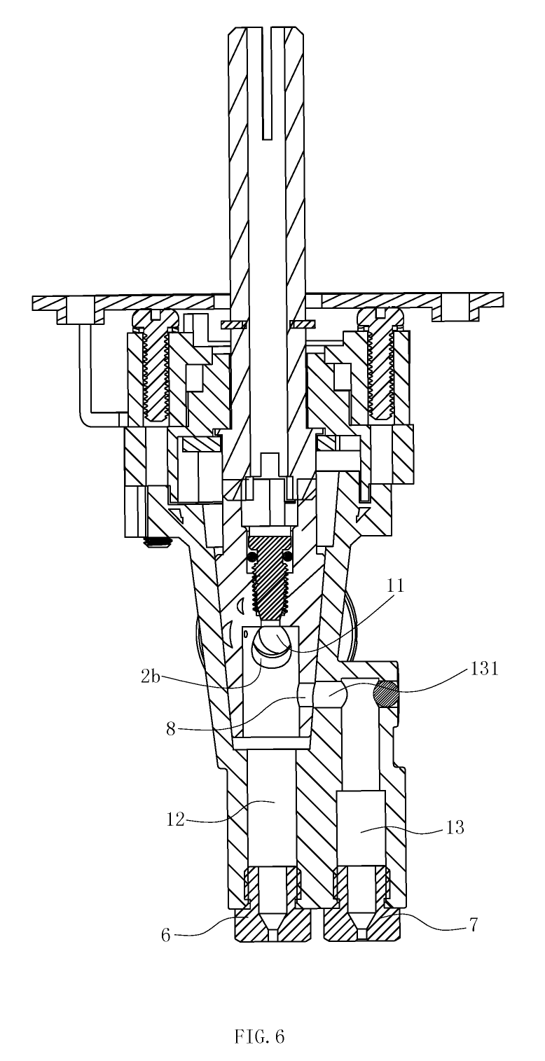

As shown in FIGS. 5 and 6, when the valve core is rotated from the second angle β to a third angle θ which may be 230°, the inlet 11 is in communication with the second high fire hole 2b, the inlet 11 is not in communication with the first high fire hole 2a and the low fire hole 5, and the supplementary fire hole 8 is communicated with the secondary outlet 13.

An axis of the primary outlet 12 is parallel to an axis of the secondary outlet 13, a connecting hole 131 for communication the secondary outlet with the second high fire hole 2b is formed on a side wall of the top of the secondary outlet 13.

As shown FIGS. 7-11, the ventilation chamber 31 and the connection chamber 32 are connected to each other through a threaded connection hole 33 which is axially defined disposed the valve core 3; an auxiliary low fire hole 51 communicating with the threaded connection hole 33 is formed on a side wall of the valve core 3; the auxiliary low fire hole 51 is located above the low fire hole 5; an adjustment screw 9 is movably disposed within the threaded connection hole 33, and the adjustment screw 9 moves inside the threaded connection hole 33 so as to adjust communication between the auxiliary low flame hole 51 and the ventilation chamber 31.

The threaded connection hole 33 has a threaded hole portion 331 at the upper thereof and an unthreaded hole portion 332 at the lower thereof; the auxiliary low fire hole 51 is communicated with the threaded hole portion 331; the adjustment screw 9 has a head 91, an annular groove portion 92, a threaded portion 93 and an unthreaded rod portion 94 successively from top to bottom; an inner peripheral wall of the connection chamber 32 is sheathed on the annular groove portion 92 to form an airtight seal ring 10; the threaded portion 93 is in threaded connection to the threaded hole portion 331, and the unthreaded rod portion 94 can realize blockage with the unthreaded hole portion 332. The unthreaded rod portion 94 has a conical periphery surface, and the unthreaded hole portion 332 has a conical inner wall matching with the unthreaded rod portion 94. Both the low fire hole 5 and the auxiliary low fire hole 51 have a step at the side wall thereof.

The operation principle and process of the present invention are as follows.

As shown in FIG. 3, when the valve core is rotated from the initial position (0°) to a first angle α (90°), the inlet 11 is in communication with the first high fire hole 2a, the inlet 11 is not in communication with the second high fire hole 2b and the low fire hole 5, and the supplementary fire hole 8 is not in communication with the secondary outlet 13. In this case, it is in a high flame state.

As shown in FIG. 4, when the valve core is rotated from the first angle α (90°) to a second angle β (165°), the inlet 11 is communicated with the low fire hole 5, the inlet 11 is not in communication with the first high fire hole 2a and the second high fire hole 2b, and the supplementary fire hole 8 is not in communication with the secondary outlet 13. In this case, it is in a low flame state. When a gas having high heat is needed, it is only required to screw the adjustment screw 9, so that the unthreaded rod portion 94 of the adjustment screw 9 blocks an outlet end of the unthreaded hole portion 332 of the threaded connection hole, and the auxiliary low fire hole 6 is not in communication with the ventilation chamber 2. As a result, only the low fire hole 5 works, and the gas flow becomes lower. However, when a gas having high heat is needed, the adjustment screw 9 is unscrewed, so that the unthreaded rod portion 94 of the adjustment screw 9 is disconnected from the unthreaded hole portion 332 of the threaded connection hole, and the auxiliary low fire hole 51 is communicated with the ventilation chamber 31 through the unthreaded hole portion 332. As a result, both the low fire hole 5 and the auxiliary low fire hole 51 are communicated with the ventilation chamber 31, and the gas flow becomes higher.

As shown in FIGS. 5 and 6, when the valve core is rotated from the second angle β (165°) to a third angle θ (230°), the inlet 11 is in communication with the second high fire hole 2b, the inlet 11 is not in communication with the first high fire hole 2a and the low fire hole 5, and the supplementary fire hole 8 is communicated with the secondary outlet 13. In this way, gas is communicated with the primary outlet 12 through the inlet 11, the second high fire hole 2b and the ventilation chamber 31. Meanwhile, the gas is communicated with the secondary outlet through the ventilation chamber 31 and the supplementary fire hole, so that gas is injected from both the primary outlet and the secondary outlet. During this process, the valve rod does not need to be operated manually, and the valve core is automatically kept at this position. When the two-nozzle mode is not required, it is only required to rotate the valve rod reversely, and the operation is more humanized.

When the valve core is rotated to a certain angle, it is ensured that the inlet is communicated with the second high fire hole, the inlet is not in communication with the first high fire hole and the low fire hole, and the supplementary fire hole is communicated with the secondary outlet.

1. A gas valve with two nozzles, comprising:
a valve body having an inlet, a primary outlet and a secondary outlet;
a rotatable valve core, disposed inside the valve body, having an upper portion and a lower portion;
a valve rod inserted into the valve body;
a first nozzle connected to a first outlet end of the primary outlet; and
a second nozzle connected to a second outlet end of the secondary outlet;
wherein, a connection chamber with a top opening for receiving the valve rod is mounted on the upper portion of the valve core;
a ventilation chamber in communication with the primary outlet is defined in the lower portion of the valve core, the ventilation chamber having a side wall;
a first high fire hole and a low fire hole both for communication between the inlet and the primary outlet are defined on the side wall of the ventilation chamber; and
a second high fire hole for communication between the inlet and the primary outlet and a supplementary fire hole for communication between the ventilation chamber and the secondary outlet are defined on the side wall of the ventilation chamber of the valve core.

2. The gas valve of claim 1, wherein the inlet, the first high fire hole, the second high fire hole, the low fire hole, the supplementary fire hole and the secondary outlet meet the following conditions:
when the valve core is rotated from an initial position to a first angle, the inlet is in communication with the first high fire hole, the inlet is not in communication with the second high fire hole and the low fire hole, and the supplementary fire hole is not in communication with the secondary outlet;
when the valve core is rotated from the first angle to a second angle, the inlet is communicated with the low fire hole, the inlet is not in communication with the first high fire hole and the second high fire hole, and the supplementary fire hole is not in communication with the secondary outlet;
when the valve core is rotated from the second angle to a third angle, the inlet is in communication with the second high fire hole, the inlet is not in communication with the first high fire hole and the low fire hole, and the supplementary fire hole is communicated with the secondary outlet.

3. The gas valve of claim 1, wherein an axis of the primary outlet is parallel to an axis of the secondary outlet, a connecting hole for communication the secondary outlet with the second high fire hole is formed at a side wall of the top of the secondary outlet.

4. The gas valve of claim 1, wherein the ventilation chamber and the connection chamber are connected to each other through a threaded connection hole which is axially defined inside the valve core; an auxiliary low fire hole communicating with the threaded connection hole is formed on a side wall of the valve core; the auxiliary low fire hole is located above the low fire hole; and, an adjustment screw is movably disposed within the threaded connection hole, and the adjustment screw moves inside the threaded connection hole so as to adjust communication between the auxiliary low fire hole and the ventilation chamber.

5. The gas valve of claim 4, wherein the threaded connection hole has a threaded hole portion at the upper thereof and an unthreaded hole portion at the lower thereof; the auxiliary low fire hole is communicated with the threaded hole portion; the adjustment screw has a head, an annular groove portion, a threaded portion and an unthreaded rod portion successively from top to bottom; an inner peripheral wall of the connection chamber is sheathed on the annular groove portion to form an airtight seal ring; the threaded portion is in threaded connection to the threaded hole portion; and the unthreaded rod portion can realize blockage with the unthreaded hole portion.

6. The gas valve of claim 5, wherein the unthreaded rod portion has a conical periphery surface, and the unthreaded hole portion has a conical inner wall matching with the unthreaded rod portion.

7. The gas valve of claim 4, wherein both the low fire hole and the auxiliary low fire hole have a step at the side wall thereof.

8. The gas valve of claim 4, wherein a perforation for allowing an adjustment hand tool to pass through is arranged on the valve rod.

9. The gas valve of anyone of claim 1, wherein a valve housing and a valve cover connecting with each other forms the valve body; all the inlet passage, the primary outlet passage and the secondary outlet passage are arranged on the valve housing; and the valve rod is inserted through the valve cover.
